(19) United States
(12) Patent Application Publication
(10) Pub. No.: US 2004/0091128 A1
(43) Pub. Date: May 13, 2004

(54) Fixable-wire earphone

(76) Inventor: Sung Hwan Park, Seoul (KR)

Correspondence Address: CANTOR COLBURN, LLP, 55 GRIFFIN ROAD SOUTH, BLOOMFIELD, CT, 06002

(21) Appl. No.: 10/469,719

(22) PCT Filed: Mar. 2, 2002
(86) PCT No.: PCT/KR02/00357

(30) Foreign Application Priority Data
Mar. 2, 2001 (KR) 2001-0005655

(51) Int. Cl. H04R 25/00

(52) U.S. Cl. 381/380; 381/374

(57) ABSTRACT

The electric cord of a regular earphone often gets tangled and twisted when it is routinely used. That leads a user to make an effort to ravel it out more often than not. The electric cord of the Fixable-Cord earphone presented here is capable of being fixed to any shape because of the special iron wire embedded in the electric cord. Since the iron wire embedded can be modified to any shapes and maintained as it is, the users do not have to make an effort to unravel the tangled wire every time when they use it. They can keep it neat just by winding the electric cord on a tape recorder. This property provides another advantages also.

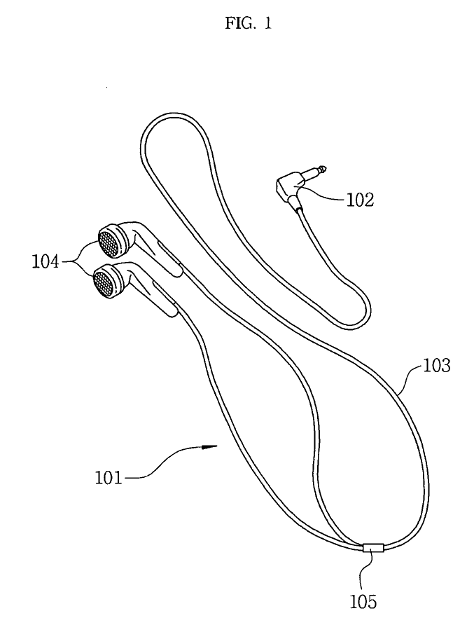

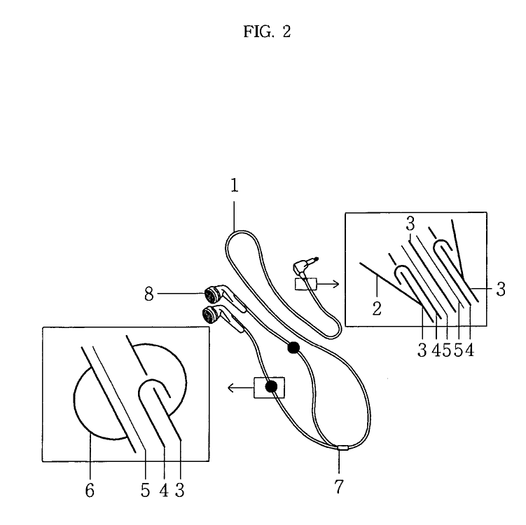

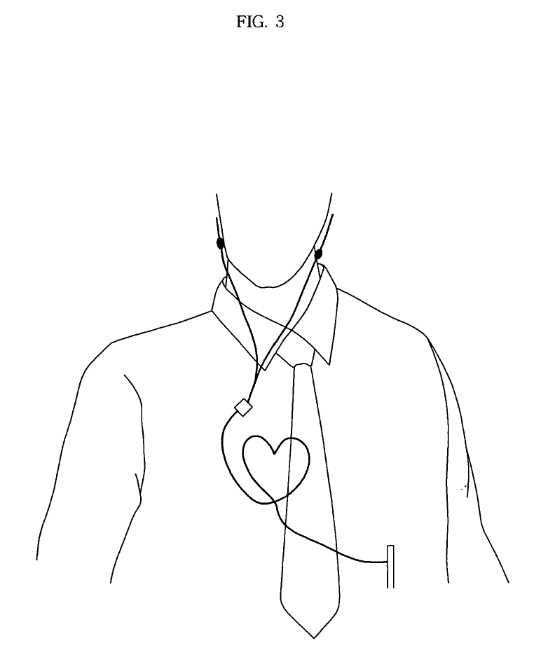

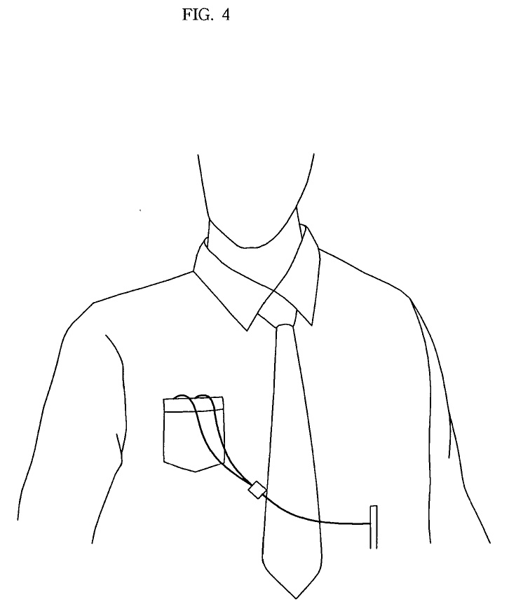

### TECHNICAL FIELD

This invention is for the Fixable-Cord Earphone, which is embedded a thin pliable iron wire to allow users to shape the cord into whatever they want. This property provides three main values to the users; aesthetic value, manageability, handiness. First, the users can shape the remaining cord into some fancy forms like a heart or a star to express their unique identities. It is not only an electronic device but also a fashion accessory. Second, if the user winds it around a portable recorder while not used, it will not mess up since it maintains the form once fixed. Last, when the user does not use it temporarily, it can be shaped like a hook that can be set up on the pockets or bags to the user's handiness. Ultimately these values resulted in better durability.

### BACKGROUND ART

Generally, an earphone is for portable sound devices or voice communication devices. It is smaller and handier than usual headphone. So, it extends its usage from a tape recorder to a wireless phone.

It requires simplicity and handiness both in function and design aspects to come with the portable devices.

Here you see the usual design of an existing earphone at first. As you see in the Drawing 1, a jack (102) is installed in one side terminal of earphone cord that connects earphone (101) to a terminal of a sound device. At the end of the above jack a wire is connected. There is a slide-in connector (105) where the wire is divided into two twigs and the connector enables the adjustment of the lengths of the twigs. Phones (104) are connected at the end of each twig.

When a user listens to the music from a tape recorder with an existing device like above, he/she plugs the jack (102) into phone jack of a portable recorder and listens through the phones that are installed in each twig.

The problem is in the wire that connects through both of the phones. It gets tangled and twisted easily while using and keeping to the user's inconvenience. Furthermore, the efforts of ravel it out sometimes make the wire disconnected so the earphone cannot be used anymore. Another inconvenience of this existing earphone is user can not handle the phones while not used temporarily but hold it in the air.

### DISCLOSURE OF INVENTION

This is addressed to cope with above problems of existing devices. This can be wound on a tape recorder while not used and would not be messed up since it remains the fixed shape. It prevents the cord from entanglement. It also can be fixed on any objects like bags or clothes just like a hook.

This shapability and fixity come from the iron wire embedded in the cord that is thin and pliable. Both ends of the wire are drawn out of the cord and grounded with plastic shields to prevent disconnecting.

Again, the earphone described above can be shapeable and have fixity because of the plastic deformation of the special iron wire is maintained. A user can shape it into a circle, a triangle, a heart or a star to be matched with the clothes or by his/her fancy. When temporarily unused, the user then set up the phone on the pocket by shaping it into a hook or fixed on a strap of a bag by just winding it. While not used for a long time, it just can be wound on a recorder and it will not be messed up until the next time when the user draws it out. This provides durability of the earphone as well as the handiness by preventing the risks of the electric wire from disconnecting.

### BRIEF DESCRIPTION OF DRAWINGS

The attached drawings of the design included in this specification are to exemplify a desirable implementation of the invention and explain the principle of the invention.

In the drawings,

Drawing 1 is a projection of an existing earphone;

Drawing 2 is a cross-sectional view of an enlarged Fixable-Cord earphone implemented by this invention;

Drawing 3 is a projection of a Fixable-Cord earphone shaped into a heart;

Drawing 4 is a projection that shows the status of the Fixable-Cord earphone hooked up on a user's clothes.

* Description of the signs used in the main parts of the drawings*

| | |
|---|---|
| 1: Earphone | 2: Jack |
| 3: Wire Cover | 4: Iron Wire |
| 5: Electric Wire | 6: Plastic for preventing disconnecting |
| 7: Connector | 8: Phone |

### BEST MODE FOR CARRYING OUT THE INVENTION

You see a desirable implementation of this invention as follows. It is described by referring the attached drawings.

Drawing 2 is a cross-sectional view of an enlarged Fixable-Cord earphone. Drawing 3 is a projection of a heart-shaped Fixable-Cord earphone. And drawing 4 is a projection that shows the status of the Fixable-Cord earphone hooked up on a user's clothes. We see an earphone (1) and a jack (2) to connect a user to a sound device. The thin and pliable iron wire is embedded in the cord from the upper phone (8) through the jack (2) and the end of the iron wire is out of the cord to protect the electric wire from disconnecting and shielded by plastic. (6)

The plastic transformability of the iron wire makes this earphone (1) pliable and maintains the shape. It provides the unique property to the earphone that prevents entanglement of the cord and enables shaping by user's fancy. This flexible shapability makes the things possible that showed in drawing 3 and drawing 4.

Meanwhile, the application of this Fixable-Cord earphone (1) is not limited in the stereophonic earphone in the drawing 2. It is applicable to a monophonic earphone with one twigs and a hands-free earphone for a car. The application can be extended to any industrial earphone to provide a user with this convenience.

### INDUSTRIAL APPLICABILITY

By using this Fixable-Cord earphone, a user can shape the remaining cord into some fancy forms like a heart or a star to express their unique identities and some fashion sense. When it is not used, it can be wound on a recorder and kept neat since it remains as it is. It also can be hooked up on clothes or bag of the user while not used momentarily. It provides handiness and improved usability, with enhanced durability.

What is claimed is:

1. The earphone with the shapability and fixity. Those properties come from a special iron wire embedded in the cord that is thin and pliable. The iron wire embedded in the cord is put from the upper phone (8) through the jack (2) and the end of the iron wire is out of the cord to protect the electric wire from preventing and shielded by plastic. (6)

2. In item 1, the earphone with same properties embedded with an alloy line instead of an iron wire.

3. In item 1, the earphone with same properties embedded with a plastic line instead of an iron wire.
